(19) United States
(12) Patent Application Publication
(10) Pub. No.: US 2024/0344388 A1
(43) Pub. Date: Oct. 17, 2024

(54) Lift Ring for a Window Treatment System

(71) Applicant: Lutron Technology Company LLC, Coopersburg, PA (US)

(72) Inventors: William Taylor Shivell, Breinigsville, PA (US); Zachary Thé, Newark, DE (US)

(73) Assignee: Lutron Technology Company LLC, Coopersburg, PA (US)

(21) Appl. No.: 18/619,426

(22) Filed: Mar. 28, 2024

Related U.S. Application Data
(60) Provisional application No. 63/495,575, filed on Apr. 12, 2023.

(51) Int. Cl. E06B 9/322; E06B 9/262

(52) U.S. Cl. CPC E06B 9/322; E06B 9/262; E06B 2009/2625; E06B 2009/3225

(57) ABSTRACT

A window treatment system may include one or more lift rings (e.g., cord guides) for guiding flexible members (e.g., cords and/or ribbons) when wrapping around a roller tube of the window treatment system. Each of the lift rings may comprise a body that is ring-shaped and defines a central opening configured to receive the roller tube. The body may extend from a first end to a second end, where the first end is spaced apart from the second end by a gap. The body may be configured to be deformed by the first and second ends of the body being pulled in opposite directions to increase the size of the gap, such that the roller tube may be received through the gap. The body may be configured to reform when released, such that the roller tube is received in the central opening of the body.

### CROSS-REFERENCE TO RELATED APPLICATIONS

This application claims priority to U.S. Provisional Patent Application No. 63/495,575, filed on Apr. 12, 2023, the entire disclosure of which is incorporated by reference herein.

### DESCRIPTION OF THE RELATED ART

Typical window treatments (e.g., such as, for example, roller shades, draperies, Roman shades, and Venetian blinds) may be mounted in front of windows to prevent sunlight from entering a space and/or to provide privacy. Many types of window treatments may be moved between a raised position (e.g., a fully-raised position and/or an open position) and a lowered position (e.g., a fully-lowered position and/or a closed position), as well placed in any number of positions between the raised and lowered positions. The actuation of the window treatments may be manual or powered. For powered systems, which use a motor to control the movement of the window treatments, the motor may be powered by a power source. The power source may be a fixed power source, e.g., an alternating-current (AC) source or a direct-current (DC) power source connected to the internal electrical wiring of the dwelling (e.g., home, office, etc.), or may be from a temporary or replaceable power source, such as a battery.

### SUMMARY

As disclosed herein, a window treatment system may include one or more guide members, such as lift rings (e.g., cord guides), for guiding flexible members (e.g., cords and/or ribbons) when wrapping around a roller tube of the window treatment system. The roller tube may be rotatably supported for brackets of the window treatment system. The window treatment system may comprise a covering material extending from a location adjacent to the roller tube to a bottom end (e.g., to hang and cover an opening, such as a window). The flexible member may extend from the roller tube to a bottom end of the covering material for raising and lowering the covering material in response to rotations of the roller tube in first and second angular directions, respectively.

Each of the lift rings may comprise a body that is ring-shaped and defines a central opening configured to receive the roller tube. The body may extend from a first end to a second end, where the first end is spaced apart from the second end by a gap. The body may further comprise an outer surface and an inner surface configured to abut against an outer surface of the roller tube when the roller tube in received in the central opening. The body may comprise a first side having a sidewall that extends from the outer surface to the inner surface and a second side. In addition, the lift ring may comprise a fastener configured to be received through a first opening in the first end of the body and a second opening in the second end of the body, such that the fastener is configured to be tightened and loosened to respectively decrease and increase a diameter of the lift ring to thus adjust how tightly the lift ring is attached to the roller tube. Further, the gap may still be present when the fastener is received through the first opening in the first end and the second opening in the second and tightened until the inner surface of the body abuts the roller tube.

The body may be configured to be deformed by the first and second ends of the body being pulled in opposite directions to increase the size of the gap, such that the roller tube may be received through the gap. The body may be configured to reform when released, such that the roller tube is received in the central opening of the body. The first end of the body may be configured to be attached to the second end of the body for fixedly attaching the lift ring to the roller tube. For example, the body may be made from a flexible material, such as an unfilled nylon material. In addition, the body may comprise one or more recesses in the sidewall on the first side of the body to improve the flexibility of the body. Further, the second side of the body may be open and absent of material.

The sidewall of the body may define a cord-abutment surface against which the flexible member may be configured to abut as the flexible member wraps around the roller tube (e.g., when the flexible members are cords). In addition, the body may comprise a cord-attachment structure configured to attach a cord to the lift ring (e.g., when the flexible members are cords). Further, the body may comprise a channel configured to receive one end of a pin that may be attached to the end of a ribbon (e.g., when the flexible members are ribbons).

### BRIEF DESCRIPTION OF THE DRAWINGS

FIG. 1 is a front perspective view of a Roman shade system in a lowered position (e.g., a fully-lowered position).

FIG. 2 is a rear perspective view of the Roman shade system of FIG. 1 in the lowered position.

FIG. 3 is a front perspective view of the Roman shade system of FIG. 1 in a raised position (e.g., a fully-raised position).

FIG. 4 is a perspective view of an example of a head rail assembly of the Roman shade system of FIG. 1 where the Roman shade system comprises a single lift ring for each cord.

FIG. 5 is a perspective view of the head rail assembly of FIG. 4 where the Roman shade system comprises a pair of lift rings for each cord.

FIG. 6 is a perspective view of the head rail assembly of FIG. 4 where the Roman shade system comprises a pair of lift rings for attaching a ribbon to a roller tube of the head rail assembly.

FIG. 7 is a front view of the head rail assembly of FIG. 4.

FIG. 8 is an exploded view of the head rail assembly of FIG. 4.

FIG. 9 is a perspective view of an example motor drive unit of the head rail assembly of FIG. 4.

FIG. 10 is a left-side perspective view of the head rail assembly of FIG. 4 with brackets removed.

FIG. 11 is a right-side perspective view of the head rail assembly of FIG. 4 with brackets removed.

FIG. 12 is a right-side view of a Roman shade system that includes the head rail assembly of FIG. 12 when the Roman shade system is in a front-control configuration.

FIG. 13 is a right-side view of a Roman shade system that includes the head rail assembly of FIG. 12 when the Roman shade system in in a rear-control configuration.

FIG. 14 is a partial exploded view of the head rail assembly of FIG. 12 showing a bracket, a lift assistance subsystem, and a gear assembly of the head rail assembly in greater detail.

FIG. 15 is a perspective view of an example lift ring that may be used with a motorized window treatment system, such as the Roman shade system of FIG. 1.

FIG. 16 is a perspective view of the lift ring of FIG. 15 installed around a roller tube of the motorized window treatment system.

FIG. 17 is a first side view (e.g., a right-side view) of the lift ring of FIG. 15.

FIG. 18 is a second side view (e.g., a left-side view) of the lift ring of FIG. 15.

FIGS. 19 and 20 are perspective views of the lift ring of FIG. 15 in a deformed state illustrating how the lift ring may be installed on the roller tube.

### DETAILED DESCRIPTION

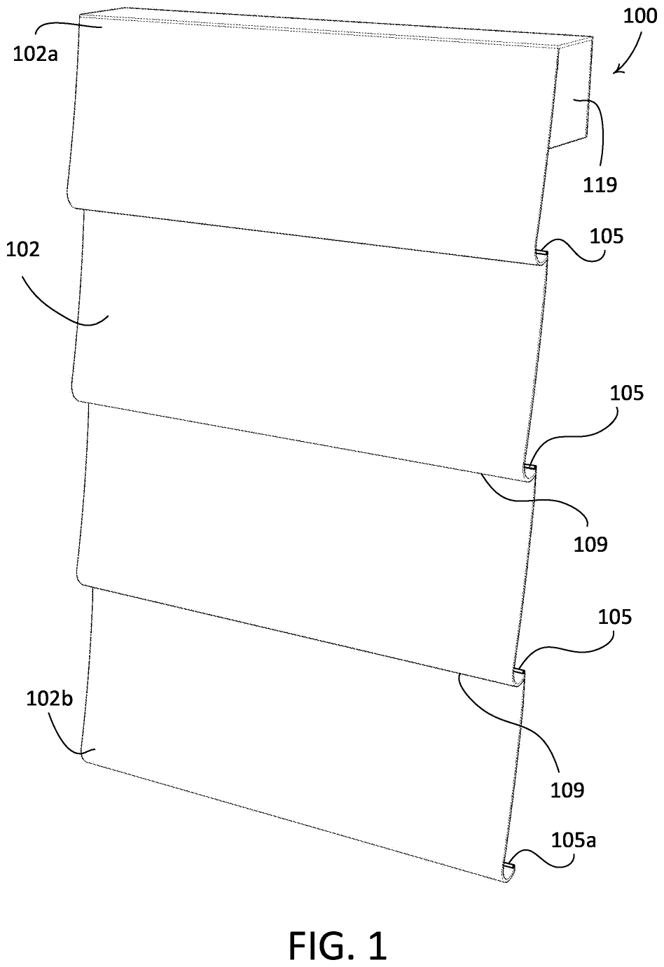

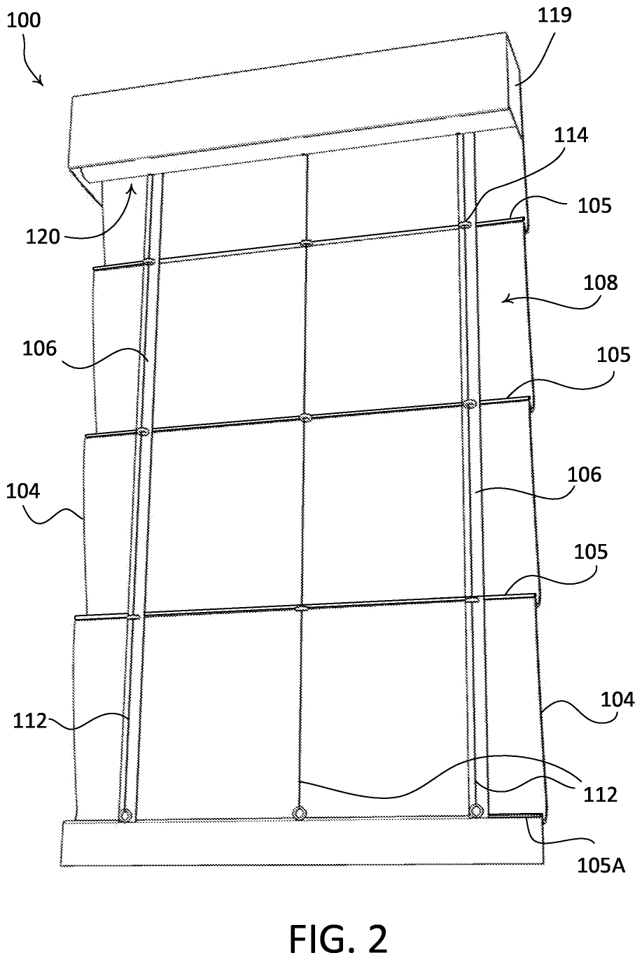

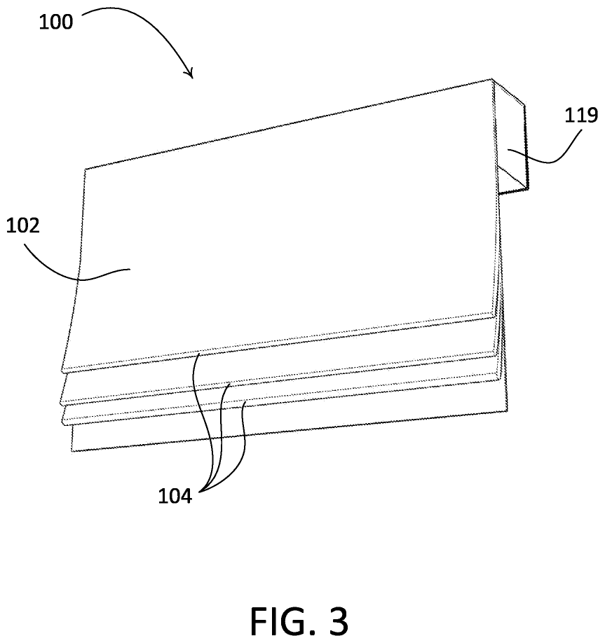

FIG. 1 is a front perspective view and FIG. 2 is a rear perspective view of a window treatment system, such as a Roman shade system 100, in a lowered position (e.g., a fully-lowered position and/or a closed position). FIG. 3 is a front perspective view of the Roman shade system 100 in a raised position (e.g., a fully-raised and/or an open position). The Roman shade system 100 may include a covering material, such as a shade fabric 102 (e.g., a hobbled shade fabric), which may be adapted to fold into a plurality of pleats 104 (e.g., horizontal pleats) as the Roman shade system 100 is opened. The pleats 104 may be formed by rigid battens 105 (e.g., dowels), which are sewn into the shade fabric 102 and extend horizontally across the width of the shade fabric. The Roman shade system 100 may comprise two or more ribbons 106 that extend along the length of a rear surface 108 of the shade fabric 102 and are attached to the rear surface 108 of the shade fabric 102 at the battens. Accordingly, the shade fabric 102 (e.g., the hobbled shade fabric) may hang with a plurality of folds 109 when the Roman shade system 100 is in the lowered position as shown in FIGS. 1 and 2. The Roman shade system 100 may include one or more flexible members, such as cords 112 (e.g., three cords as shown in FIG. 2), which allow for raising and lowering of the shade fabric 102. The cords 112 may be attached to a lowest one 105a of the battens 105 and pass through a plurality of eyelets 114 (e.g., attachment points) that are coupled to the rear surface 108 of the shade fabric 102. The eyelets 114 may be coupled to the battens. Although three cords 112 are illustrated, it should be understood that fewer (e.g., one or two) or more cords may be used.

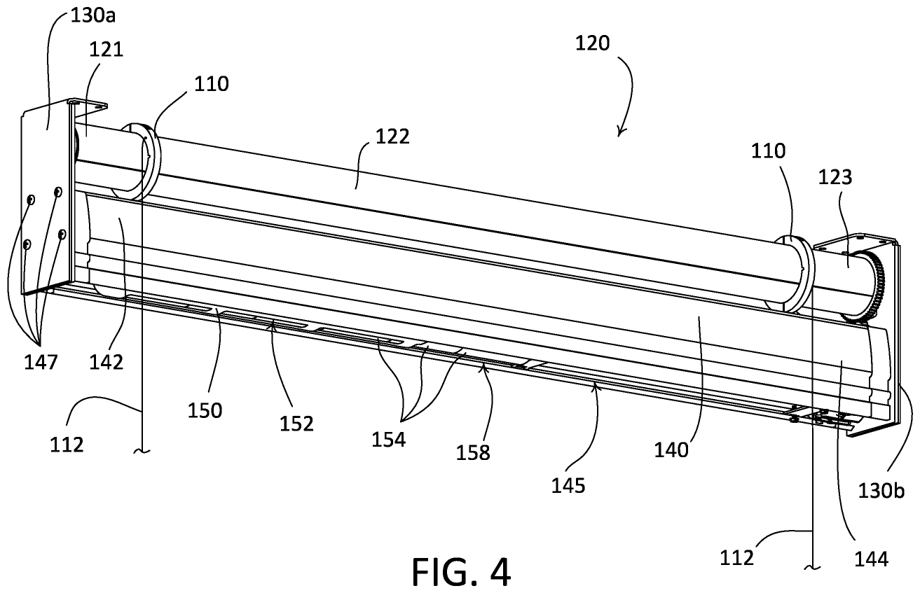

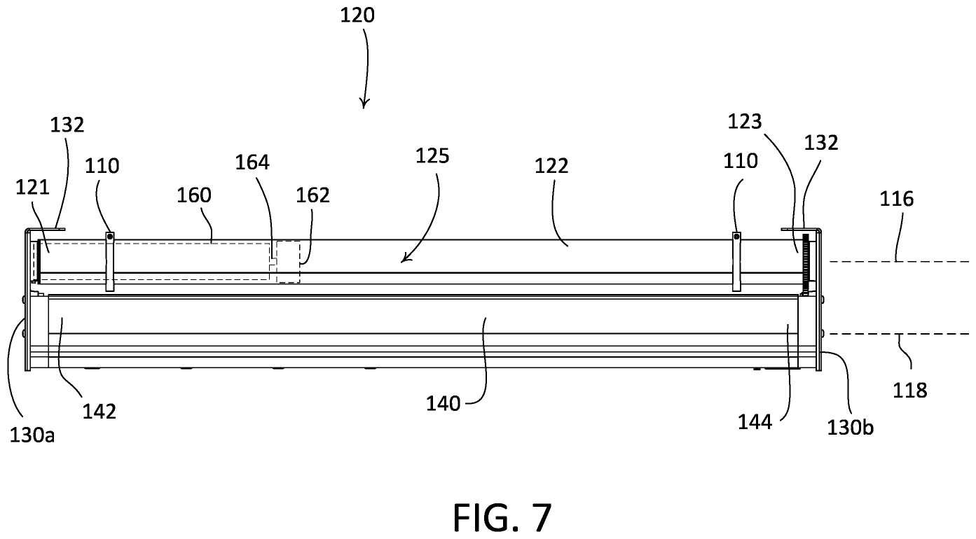

The Roman shade system 100 may comprise a head rail assembly 120, which may be located in an enclosure 119 (e.g., as shown in FIG. 2). FIG. 4 is a perspective view of the head rail assembly 120. The head rail assembly 120 may comprise a roller tube 122 that may be configured to rotate about a first axis 116 (FIG. 7), which may be a longitudinal axis of the roller tube 122. The roller tube 122 may have a cylindrical shape and may extend from a first end 121 to a second end 123. As shown in FIGS. 1-3, the shade fabric 102 (e.g., a top end 102a of the shade fabric 102) may be attached (e.g., fixedly attached) to the enclosure 119 surrounding the head rail assembly 120 and may be configured to hang from the enclosure 119 (e.g., for covering an opening, such as a window). The cords 112 may be coupled to the roller tube 122 of the head rail assembly 120. The cords 112 may be configured to wrap around the roller tube 122 and a bottom end 102b of the shade fabric 102 may be configured to move as the roller tube 122 rotates. The enclosure 119 may hide the head rail assembly 120 from view. While the Roman shade system 100 is shown with the head rail assembly 120 located in the enclosure 119 in FIGS. 1-3, the head rail assembly 120 may also be installed without the enclosure 119 and the top end of the shade fabric 102 may be attached to a portion of the structure of the building around the head rail assembly 120.

The Roman shade system 100 may comprise one or more guide members, such as lift rings 110 (e.g., cord guides and/or collars), coupled to the roller tube 122 for guiding the cords 112 as the cords wind around and unwind from the roller tube 122. The lift rings 110 may each extend around the roller tube 122. For example, the Roman shade system 100 may comprise one lift ring 110 (e.g., a single lift ring) for each of the cords 112 of the Roman shade system 100. Each cord 112 may be attached to the respective lift ring 110 (e.g., such as at an inner side of the left lift ring 110 near the roller tube 122) and may extend from the lift ring 110 such that the cord 112 wraps around the roller tube 122 adjacent to one side of the respective lift ring 110 as the roller tube 122 rotates. While two lift rings 110 are shown in FIG. 4, the Roman shade system 100 may comprise more than two lift rings 110 around the roller tube 122 depending on the number of cords 112 required for the shade fabric 102 (e.g., one lift ring 110 for each cord 112).

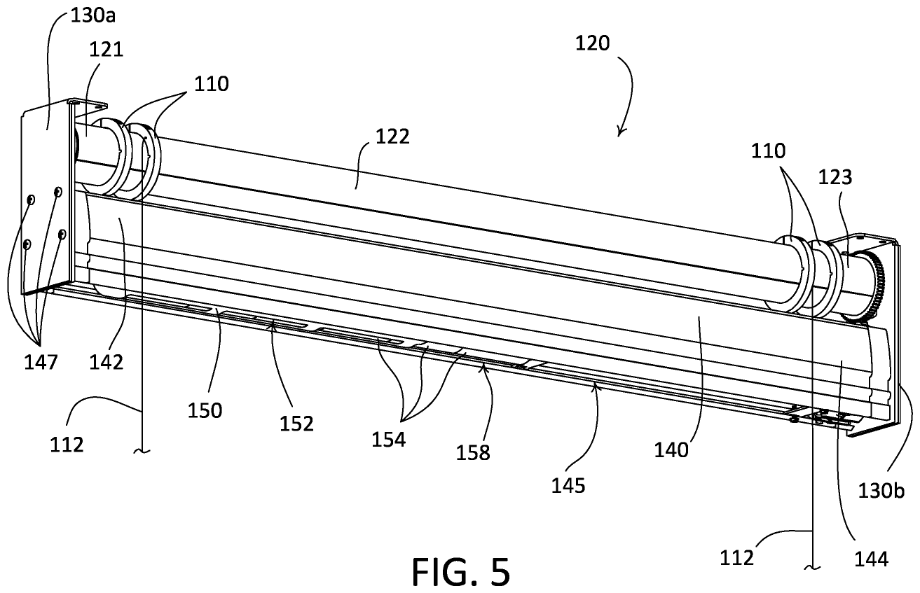

In addition, the Roman shade system 100 may comprise a pair of lift rings 110 for each of the cords 112 in the Roman shade system 100, e.g., as shown in FIG. 5. The lift rings 110 of each pair of lift rings 110 may be spaced apart from each other along the roller tube 122. Each cord 112 may be attached to one of the lift rings 110 of each pair of lift rings 110, and may extend from the lift ring 110 such that the cords 112 may wrap around the roller tube 122 between the pair of lift rings 110 as the roller tube 122 rotates. While two pairs of lift rings 110 are shown in FIG. 5, the Roman shade system 100 may comprise more than two pairs of lift rings 110 around the roller tube 126 depending on the number of cords 112 required for the shade fabric 102 (e.g., one pair of lift rings 110 for each cord 112).

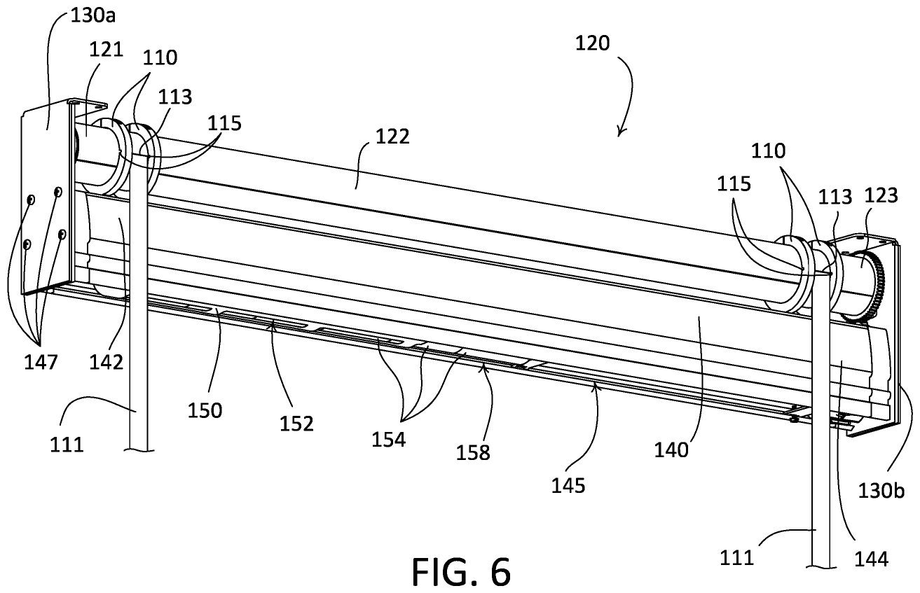

Further, rather than using the cords 112, the Roman shade system 100 may comprise one or more flexible members, such as ribbons 111 (e.g., straps) as shown in FIG. 6. For example, the ribbons 111 may have a narrow width (e.g., approximately ¼ inch or less). The ribbons 111 may each wrap around the roller tube 122 between adjacent lift rings 110 of each pair of lift rings 110. The Roman shade system 100 may comprise a pair of lift rings 110 for each of the ribbons 111 in the Roman shade system 100. Each ribbon 111 may be attached to a pin 113 (e.g., a rod) at one end of the ribbon 111. The pin 113 may be configured to be received in respective channels 115 in the lift rings 110 of each pair of lift rings 110. The lift rings 110 (of each pair of lift rings 110) may be spaced apart from each other along the roller tube 122, such that the pin 113 extends between the adjacent lift rings 110 and the ribbons 111 wrap around the roller tube 122 between the lift rings 110 as the roller tube 122 rotates. While two ribbons 111 and two pairs of lift rings 110 are shown in FIG. 6, the Roman shade system 100 may comprise more than two ribbons 111 and respective pairs of lift rings 110 around the roller tube 126 depending on the number of ribbons 111 required for the shade fabric 102 (e.g., one pair of lift rings 110 for each ribbon 111).

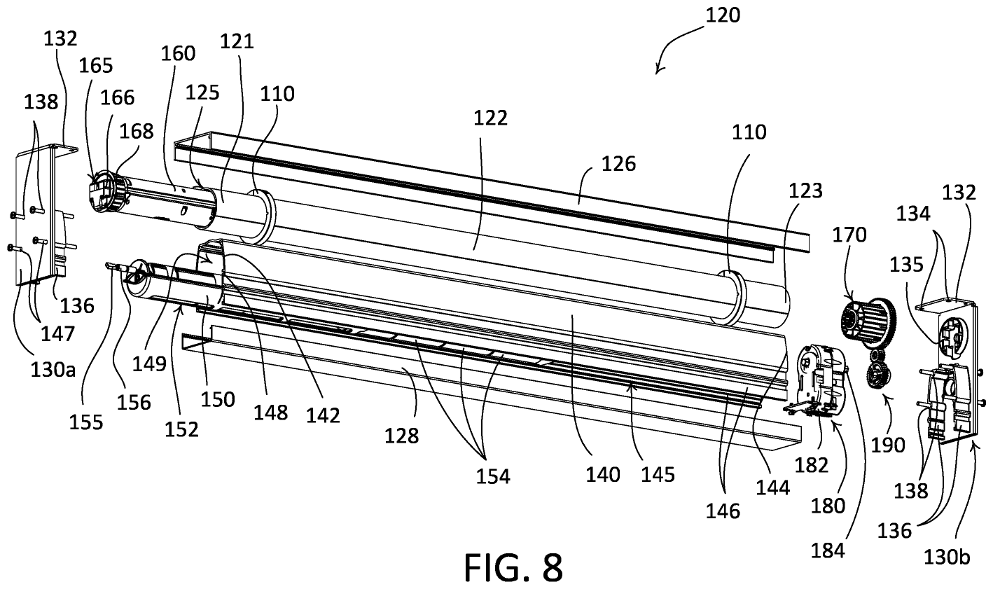

FIG. 7 is a front view and FIG. 8 is an exploded view of the head rail assembly 120. The roller tube 122 may be hollow such that the roller tube 122 defines an internal cavity 125 sized and configured to receive a motor drive unit 160 (e.g., a motor drive assembly) as shown in FIG. 7. For example, the position of the motor drive unit 160 in the roller tube 122 may be illustrated by a dashed line in FIG. 7. The motor drive unit 160 may be received in the first end 121 of the roller tube 122. One example of a motor drive unit is disclosed in U.S. Pat. No. 6,983,783, issued Jan. 10, 2006, entitled MOTORIZED SHADE CONTROL SYSTEM, the entire disclosure of which is hereby incorporated by reference.

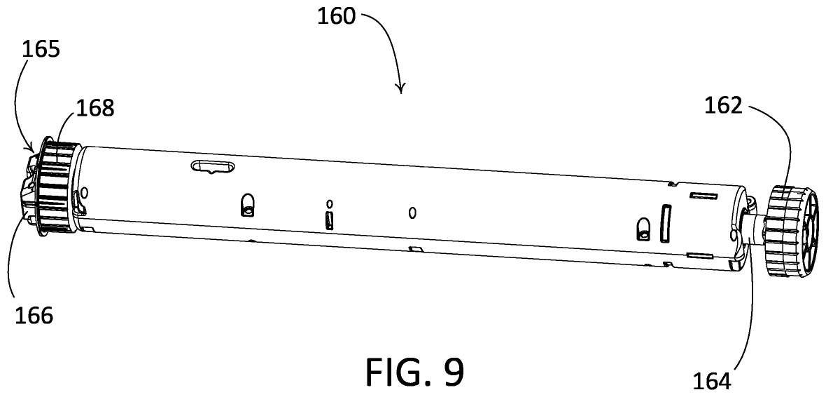

FIG. 9 is a perspective view of the motor drive unit 160 removed from the roller tube 122. The motor drive unit 160 may include an internal motor (not shown) that may be coupled to a drive coupler 162 via a drive shaft 164 for rotatably driving the drive coupler 162. The drive coupler 162 may be notched about its outer periphery to facilitate engagement between the drive coupler 162 and an interior surface of the roller tube 122 in which the motor drive unit 160 is received. The motor drive unit 160 may further comprise an end portion 165 having a connector 166, such as a male or female connector, for connecting the motor drive unit 160 to a power source, such as one or more batteries 154 (e.g., as will be described in greater detail below). The motor drive unit 160 may comprise a bearing assembly 168, which may be rotatably coupled to the roller tube 122 at the first end 121 of the roller tube 122. The second end 123 of the roller tube 120 may receive an idler assembly 170 (FIG. 8), which may be rotatably coupled to the roller tube 120 at the second end 123 of the roller tube 120.

The head rail assembly 120 may also include a first bracket 130a and a second bracket 130b for mounting the Roman shade system 100 to a structure (e.g., a wall, a ceiling, a window frame, or other structure to which the Roman shade system is to be coupled). For example, the brackets 130a, 130b may each include a flange 132 defining holes 134. The holes 134 may be sized and configured to receive fasteners (e.g., screws) for coupling the brackets 130a, 130b to the structure. The first and second brackets 130a, 130b may be configured to support (e.g., rotatably support) the roller tube 122 (e.g., via a bearing assembly of the motor drive unit 160 and the idler assembly 170). The first bracket 130a may be coupled to the end portion 165 of the motor drive unit 160 and the second bracket 130b may be coupled to the idler assembly 170 to support (e.g., rotatably support) the roller tube 122. The first and second brackets 130a, 130b may comprise respective attachment structures for attaching to the end portion 165 of the motor drive unit 160 and the idler assembly 170, respectively. For example, the second bracket 130b may comprise an attachment structure 135 configured to attach to and support the idler assembly 170 (e.g., as shown in FIG. 8). The first bracket 130a may comprise a corresponding attachment structure (not shown) configured to attach to and support the end portion 165 of the motor drive unit 160.

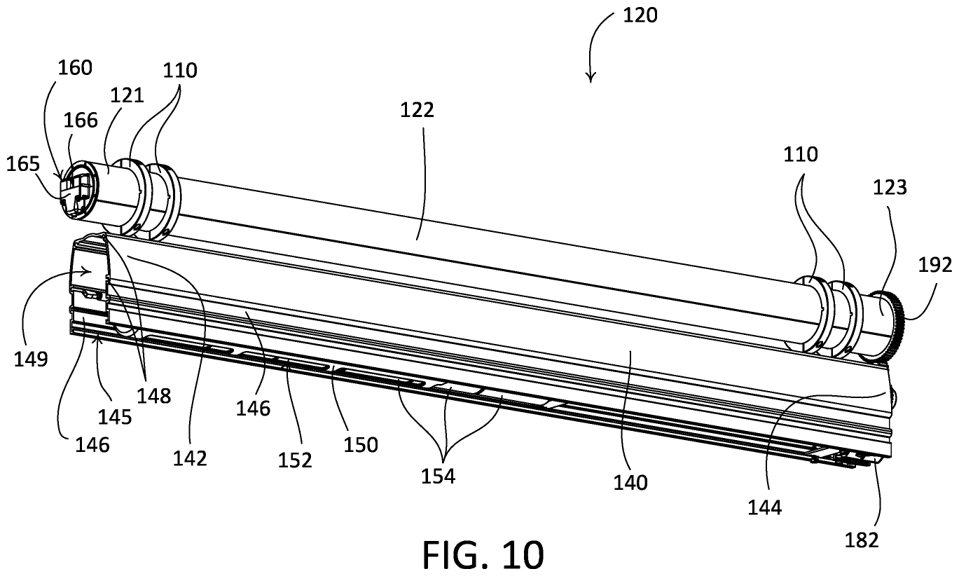

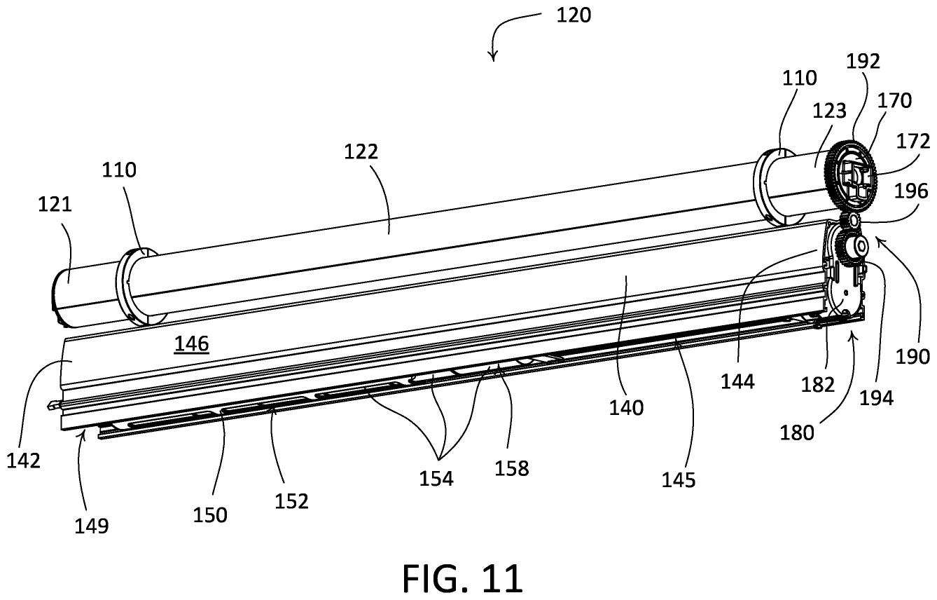

FIG. 10 is a left-side perspective view and FIG. 11 is a right-side perspective view of the head rail assembly 120 with the brackets 130a, 130b removed. The head rail assembly 120 may further include a housing 140 (e.g., an elongated housing or body), which extends from a first end 142 to a second end 144 (e.g., extends the length of the roller tube 122). The housing 140 may comprise sidewalls 146 that extend the length of the housing 140 from the first end 142 to the second end 144. The housing 140 may define an elongated slot 145 that may extend the length of the housing 140 from the first end 142 to the second end 144 (e.g., between the sidewalls 146 in a bottom of the housing 140). The first and second brackets 130a, 130b also may be configured to support (e.g., fixedly support) the housing 140. For example, the first and second brackets 130a, 130b may also include couplings, such as holes, recesses, detents, projections, and/or other physical constructions that facilitate coupling the first and second brackets 130a, 130b to the housing 140, either directly or indirectly. The first bracket 130a may be coupled to the first end 142 of the housing 140 and the second bracket 130b may be coupled to the second end 144 of the housing 140. The first and second brackets 130a, 130b may comprise walls 136 that line up with the sidewalls 146 of the housing 140. The housing 140 may be coupled to the first and second brackets 130a, 130b via fasteners 147 (e.g., screws) received in openings 138 in the first and second brackets 130a, 130b and openings 148 in the sidewalls 146 of the housing 140.

As shown in FIG. 8, the head rail assembly 120 may further comprise a top cover 126 configured to cover a top of the head rail assembly 120 and a bottom cover 128 configured to cover a bottom of the head rail assembly 120. The top cover 126 may extend the length of the head rail assembly 120 (e.g., the length of the roller tube 122) between the first and second mounting brackets 130a, 130b. The bottom cover 128 may extend the length of the head rail assembly 120 (e.g., the length of the housing 140) and may cover the elongated slot 145 in the housing 140. The top cover 126 and the bottom cover 128 may be configured to attached to the head rail assembly 120 (e.g., to the first and second mounting brackets 130a, 130b) via one or more attachment mechanisms, such as snaps and/or fasteners (e.g., screws).

The housing 140 may house a battery holder 150 that may define a battery compartment 152 that may be sized and configured to receive the one or more batteries 154 for powering the motor drive unit 160. For example, the housing 140 may define an internal compartment 149 that is sized and configured to receive the battery holder 150. The battery holder 150 may comprise a cable 156 (e.g., electrical wiring) with a plug 155 at its end. The cable 156 may be electrically connected to the batteries 154 in the battery holder 150. The plug 155 may be configured to be electrically and mechanically connected to the connector 166 of the motor drive unit 160 for powering the motor drive unit 160. The cable 156 may extend from the battery holder 150 to the motor drive unit 160 adjacent to the first bracket 130a. The battery holder 150 may comprise a spring (not shown) for pushing the batteries 154 together and holding the batteries 154 in the battery compartment 152 of the battery holder 150 when the Roman shade system 100 is installed. The number and type of the batteries 154 that may be received in the battery compartment 152 of the battery holder 150 may be based on the type of window treatment system that will be supported. In some examples, the battery compartment 152 of the battery holder 150 may be sized and configured to receive five D-cell batteries, although one of ordinary skill in the art will understand that a different number and type (e.g., size and/or capacity) of batteries may be used depending on the power needs for a particular system. For example, while five D-cell batteries are referenced, one of ordinary skill in the art will understand that fewer (e.g., 1-4) or more batteries may be used. Additionally or alternatively, other types of batteries (e.g., A, AA, AAA, and/or lithium-ion batteries) may be used instead of D-cell batteries. In some examples, the motor drive unit 160 may be powered from an external power source, such as an alternating-current (AC) power source and/or a direct-current (DC) power supply, and/or from an energy-harvesting power source, such as a photovoltaic cell (e.g., a solar cell).

As shown in FIG. 8, the battery holder 150 may be disposed at or adjacent to the first end 142 of the housing 140. Locating the motor drive unit 160 in the first end 121 of the roller tube 122 and the battery holder 150 adjacent to the first end 142 of the housing 140 may enable the plug 155 of the battery holder 150 to be electrically connected to the connector 166 of the motor drive unit 160 and may allow the cable 156 to be made as short as possible. In addition, the internal compartment 149 of the housing 140 in which the battery holder 150 is housed may be located below the roller tube 122, which may allow for easy access to the batteries 154 in the battery holder 150 when the Roller shade system 100 is installed to the structure. For example, the battery holder 150 may comprise a gap 158 (e.g., as shown in FIG. 11) through which the batteries 154 may be removed and replaced to allow for replacement of the batteries 154 through the elongated slot 145 in the housing 140. Since the batteries 154 may be received through the gap 158 in the battery holder 150 and the elongated slot 145 in the housing 140, the batteries 154 may be replaced without unmounting the head rail assembly 120 from the structure.

The head rail assembly 120 may also comprise a lift assistance subsystem 180, which may be housed and/or supported by the housing 140. For example, the internal compartment 149 of the housing 140 may also be sized and configured to receive the lift assistance subsystem 180, such that both the battery holder 150 and the lift assistance subsystem 180 may be located in the internal compartment 149 of the housing 140. The lift assistance subsystem 180 may be configured to assist the motor drive unit 160 in the cavity 125 of the roller tube 122 with adjusting the shade fabric 102 between first and second positions (e.g., raised and lowered positions). In some examples, such as when the shade fabric 102 is a Roman shade fabric, the lift assistance subsystem 180 may include a lift assistance spring 182 that may be a variable force spring, such as a negative-gradient spring, which may have a negative gradient force profile (e.g., decreasing load with increasing deflection). The lift assistance spring 182 may comprise a shaft 184 that may be configured to rotate about a second axis 118 (FIG. 7). The negative-gradient spring may provide greater assistance (e.g., a greater force) when the shade fabric 102 is near the raised position (e.g., the fully-raised position) as compared to when the shade fabric 102 is near the lowered position (e.g., the fully-lowered position), e.g., as there is less torque required to move the roller tube 122 when the shade fabric 102 is near the lowered position (e.g., the fully-lowered position) compared to when the shade fabric 102 is near the raised position (e.g., the fully-raised position).

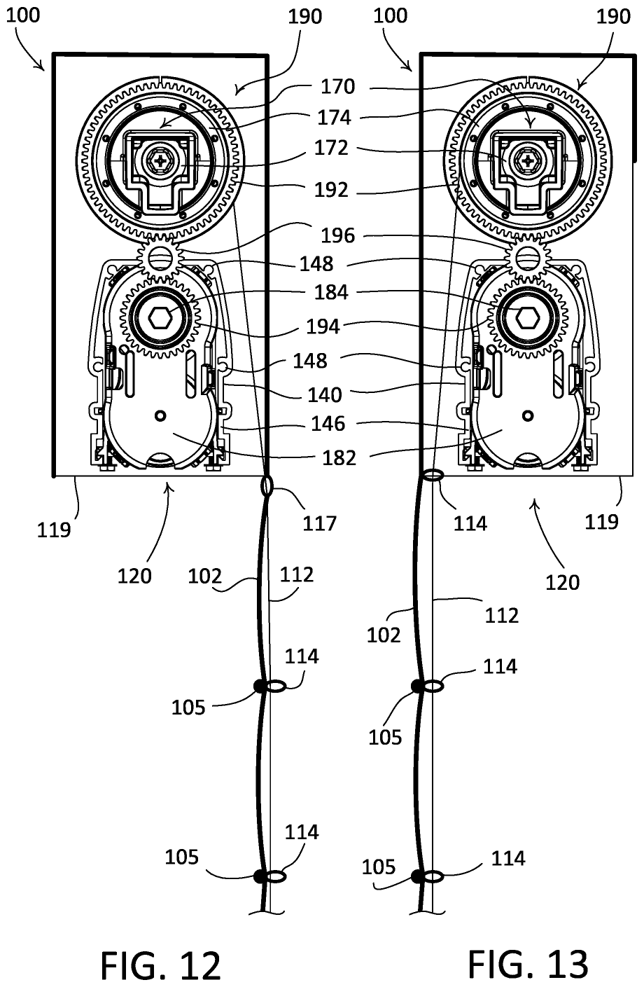

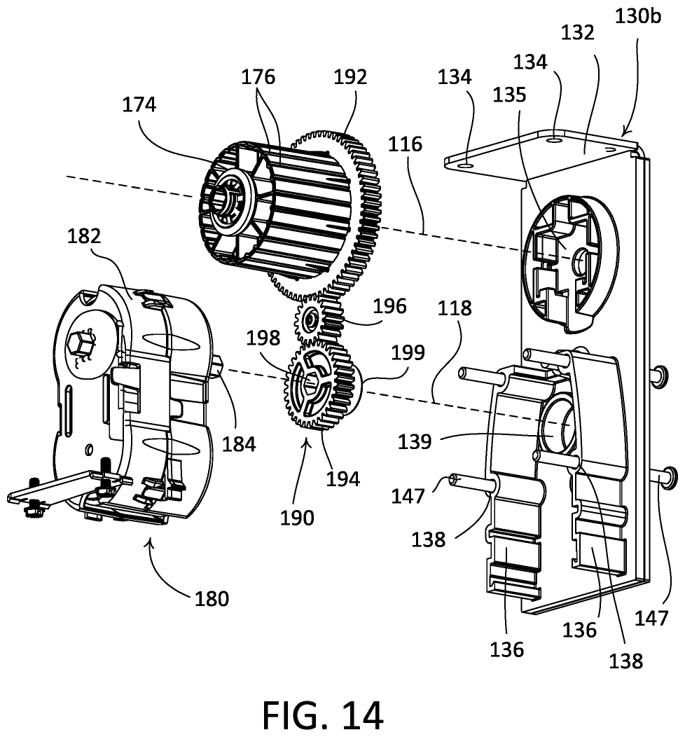

The roller tube 122 may be coupled to the shaft 184 of the lift assistance spring 182 via a gear assembly 190. FIGS. 12-13 are right side views of the Roman shade system 100 (e.g., with the right-side bracket 130b of the head rail assembly 120 not shown in order to illustrate the gear assembly 190 in greater detail). FIG. 12 shows the Roman shade system 100 in a front-control configuration (e.g., a rear-fabric configuration) and FIG. 13 shows the Roman shade system 100 in a rear-control configuration (e.g., a front-fabric configuration). FIG. 14 is a partial exploded view of the head rail assembly 120 showing the second bracket 130b, the lift assistance subsystem 180, and the gear assembly 190 in greater detail. The gear assembly 190 may be supported by the second bracket 130b and may be configured to mechanically couple the roller tube 122 to the lift assistance spring 182 of the lift assistance subsystem 180 (e.g., as will be described in greater detail below).

In the front-control configuration shown in FIG. 12, the head rail assembly 120 may be located towards the room in which the Roman shade system 100 is installed and the shade fabric 102 may be located towards the window that the Roman shade system 100 is adapted to cover (e.g., the window may be located to the right of the shade fabric 102 as shown in FIG. 12). The cords 112 may extend from the roller tube 122 through an opening 115 in the shade fabric 102 towards the lowest one of the battens 105 between the shade fabric 102 and the window. In the front-control configuration, the shade fabric 102 may hang from the window-side of the enclosure 119 and may wrap around the enclosure 119 as shown in FIG. 12 to provide an aesthetically pleasing appearance for the enclosure 119.

In the rear-control configuration shown in FIG. 13, the head rail assembly 120 may be located towards the window that the Roman shade system 100 is adapted to cover and the shade fabric 102 may be located towards the room in which the Roman shade system 100 is installed (e.g., the window may be located to the right of the shade fabric 102 as shown in FIG. 13). The cords 112 may extend from the roller tube 122 towards the lowest one of the battens 105 between the shade fabric 102 and the window. In the rear-control configuration, the shade fabric 102 may hang from the room-side of the enclosure 119 and may wrap at least partially around the enclosure 119 as shown in FIG. 13 to provide an aesthetically pleasing appearance for the enclosure 119.

The gear assembly 190 may comprise a first gear 192 that may be coupled (e.g., fixedly coupled) to the roller tube 210 (e.g., to the second end 214 of the roller tube 122) and may be configured to rotate about the first axis 116. For example, the idler assembly 170 may comprise a stationary portion 172 (FIGS. 12 and 13) configured to be attached to (e.g., fixedly attached to) the attachment structure 135 (FIG. 14) of the second bracket 130b. The idler assembly 170 may also comprise a rotatable portion 174 configured to be received in the second end 123 of the roller tube 122 and attached to (e.g., fixedly attached to) the roller tube 122. For example, the rotatable portion 174 may comprise notches 176 configured to receive ribs (not shown) on an inner surface of the roller tube for fixedly attaching the rotatable portion 174 to the roller tube 122. The rotatable portion 174 may be configured to rotate around the stationary portion 172, e.g., as the motor drive unit 160 rotates the roller tube 122. For example, the stationary portion 172 and the rotatable portion 174 may meet at a bearing surface (not shown). The first gear 192 may be connected to (e.g., formed as a part of) the rotatable portion 174 of the idler assembly 170, such that the first gear 192 rotates as the roller tube 122 rotates.

The gear assembly 190 may also comprise a second gear 194 that may be coupled (e.g., fixedly coupled) to the shaft 184 of the lift assistance spring 182 and may be configured to rotate about the second axis 118. The second gear 194 may comprise an opening 198 configured to receive and attach to the shaft 184 of the lift assistance spring 182. The second gear 194 may also comprise a drum 199 (e.g., a cylindrical drum) configured to be received (e.g., rotatably received) within an opening 139 (e.g., a cylindrical opening) in the second bracket 130b. The gear assembly 190 may comprise a third gear 196 located between the first and second gears 192, 194, and configured to mechanically couple the first gear 192 to the second gear 194. The second bracket 130b may support the first, second, and third gears 192, 194, 196 of the gear assembly 190. The engagement between the first, second, and third gears 192, 194, 196 of the gear assembly 190 may provide the connection through which the lift assistance subsystem 180 provides the assistance to the motor of the motor drive unit 160 in moving the shade fabric 102.

In operation, the motor of the motor drive unit 160 may cause the roller tube 122 to rotate in either a first angular direction (e.g., clockwise) or a second angular direction (e.g., counterclockwise) depending on whether the shade fabric 102 is to be moved toward the lowered position or toward the raised position. As the roller tube 122 rotates, the cords 112, for example, may be either wound around the roller tube 122 (e.g., guided by the lift rings 110) or unwound from the roller tube 122 depending on the direction of the rotation. When the cords 112 are wound around the roller tube 122, the cords 112 may pull on the battens 105 to cause the shade fabric 102 to raise and fold. For example, if starting in the lowered position, rotation of the roller tube 122 may cause the cords 112 to wind around the roller tube 122, which may result in the lowest one of the battens 105 (e.g., along with the shade fabric 102) being pulled in an upward direction. When the lowest one of the battens 105 contacts the next highest batten, both the lowest one of the battens 105 and the next highest one of the battens 105 may move together in an upward direction. When lowering of the shade fabric 102, all of the battens 105 may move together until a pleat is fully expanded at which point the upper-most batten may stop moving (e.g., due to its engagement with the shade fabric 102) and the remainder of the lower battens 105 may continue to move in a downward direction until all of the battens 105 reach their lowest position.

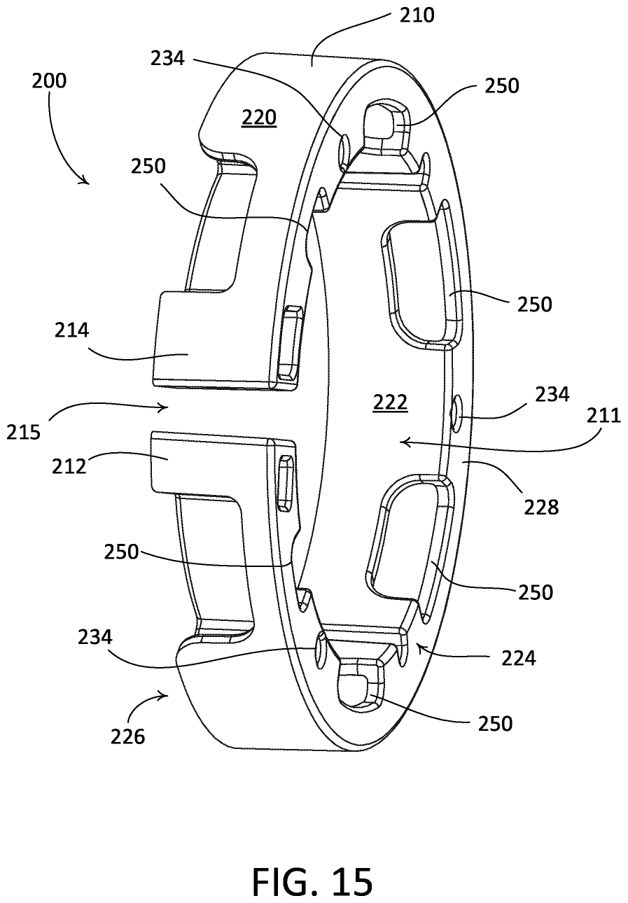

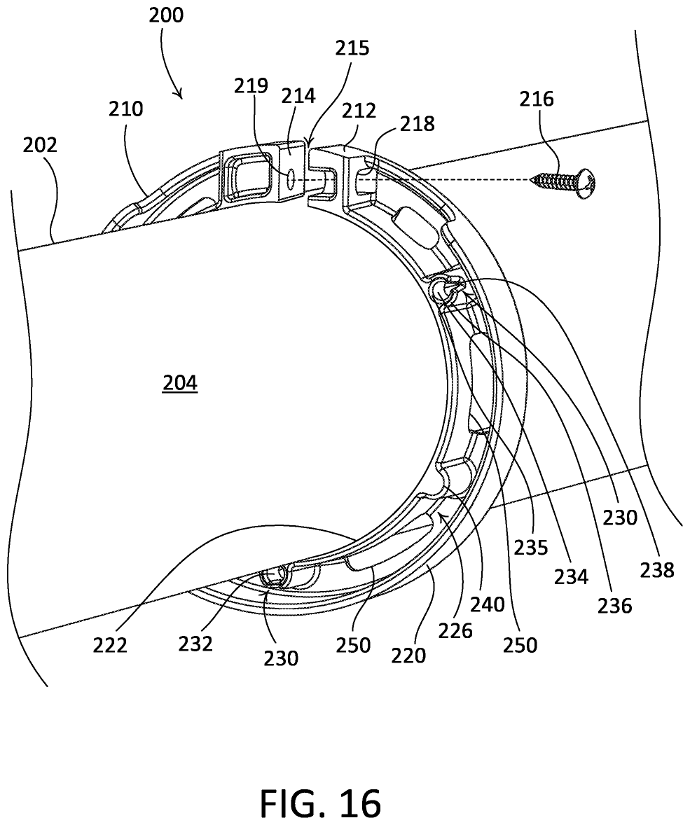

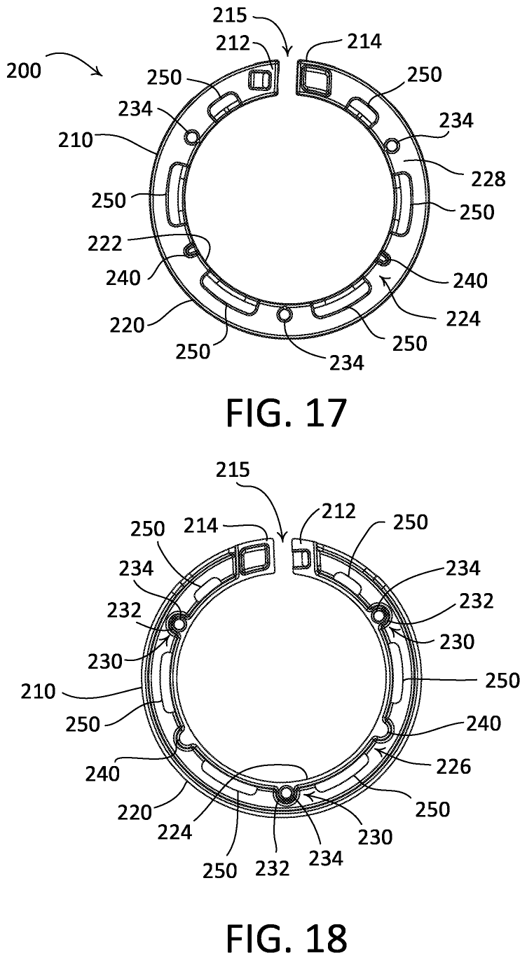

FIGS. 15-20 illustrate an example lift ring 200 (e.g., a cord guide and/or a guide member) that may be deployed as the lift rings 110 of the Roman shade system 100. The lift ring 200 may be configured to extend around a roller tube 202 (e.g., the roller tube 122), which may have a cylindrical shape. The lift ring 200 may guide a flexible member, such as a cord (e.g., one of the cords 112) and/or a ribbon (e.g., one of the ribbons 111) as the flexible member is wound around the roller tube 210. FIG. 15 is a perspective view of the lift ring 200 decoupled from the roller tube 202 and FIG. 16 is a perspective view of the lift ring 200 extending around the roller tube 202. FIG. 17 is a first side view (e.g., a right-side view) and FIG. 18 is a second side view (e.g., a left-side view) of the lift ring 200 when not attached to the roller tube 202. The lift ring 200 may comprise a body 210 that may be a broken ring defining a central opening 211 and having first and second ends 212, 214, where the first end 212 extends to the second end 214. The first and second ends 212, 214 of the body 210 may be separated by a gap 215. The central opening 211 of the body 210 may receive the roller tube 202 when the lift ring 110 is installed around the roller tube 202.

The body 210 of the lift ring 200 may comprise an outer surface 220 and an inner surface 222. The inner surface 222 may be configured to abut against an outer surface 204 of the roller tube 202 when the lift ring 200 is installed on the roller tube 202 and the roller tube 202 is received in the central opening 211 of the body 210. For example, the inner surface 222 of the body 210 of the lift ring 200 may define a circular shape to match the cylindrical shape (e.g., cylindrical periphery) of the roller tube 202. As shown in FIGS. 15-18, the outer surface 220 of the body 210 of the lift ring 200 may define a circular shape. In addition, the outer surface 220 of the body 210 may have the shape of an oval, a triangle, a square, or another polygon shape. In some examples, the body 210 of the lift ring 200 may not comprise the outer surface 220.

The body 210 of the lift ring 200 may further comprise a first side 224 (e.g., a closed side) and a second side 226 (e.g., an open side). The first side 224 may comprise a sidewall 228 that extends between the outer surface 220 and the inner surface 222 of the body 210. The sidewall 228 may define a cord-abutment surface against which the flexible member (e.g., the cord) may abut as the flexible member wraps around the roller tube 202. The second side 226 of the body 210 of the lift ring 200 may be open and absent of material (e.g., may not comprise a sidewall). While FIGS. 15-20 are described herein with cords of the Roman shade system abutting the sidewall 228 of the body 210, ribbons of the Roman shade system may also abut against the sidewall 228 of the body 210 when the Roman shade system comprises ribbons (e.g., rather than cords).

The first end 212 of the body 210 may be configured to be connected to the second end 214 via a fastener 216 (e.g., a screw) received through a first opening 218 in the first end 212 and a second opening 219 in the second end 214. For example, the second opening 219 may be threaded (or vice versa). The fastener 216 may be tightened and loosened to respectively decrease and increase a diameter the central opening 211 of the lift ring 200 to thus adjust how tightly the lift ring 200 is attached to the roller tube 202. For example, the fastener 216 may be tightened to a degree that prevents angular movement of the lift ring 200 around the roller tube 202 as the roller tube 202 is being rotated and also prevents the lift ring 200 from sliding along the roller tube 202 (e.g., in the direction of a longitudinal axis of the roller tube 202). In some instances, the gap 215 between the first end 212 and the second end 214 of the body 210 may still be present when the lift ring 200 is attached to the roller tube 202 and the fastener 216 is tightened until the inner surface 222 of the body 210 abuts the roller tube 202. The gap 215 and the fastener 216 may allow the lift ring 200 to be installed on roller tubes of different diameters.

The lift ring 200 may comprise one or more cord-attachment structures 230 (FIG. 16) for attaching the respective cord to the lift ring 200. For example, each cord-attachment structure 230 may comprise a cavity 232 (e.g., a tunnel) that extends from the first side 224 to the second side 226 of the body 210. The cavity 232 may define a first opening 234 in the sidewall 228 at the first side 224 of the body 210 and a second opening 235 at the second side 226 of the body 210. Each cord-attachment structure 230 may comprise a lip 236 that at least partially surrounds the second opening 235 at the second side 226 of the body 210. The cord may extend through the cavity 232 of one of the cord-attachment structures 230 (e.g., through the first opening 234, the cavity 232, and the second opening 235). The cord may enter the cavity 232 through the second opening 235 and exit the cavity 232 (e.g., exit the body 210) through the first opening 234, such that the cord may wrap around the roller tube 202 adjacent to the sidewall 228 (e.g., the cord-abutment surface) after exiting through the second opening 234.

The lip 236 of each of the cord-attachment structures 230 may comprise a notch 238, which may receive the cord as the cord enters the second opening 235 of the cavity 232. The end of the cord may be tied into a knot and the cord may be received in the notch 238 in the lip 236, such that the cord extends through the cavity 232 and the knot is located outside of the cavity 232 and adjacent to the notch 238. The notch 238 and/or the knot formed in the cord may be sized to prevent the knot in the cord from passing through the notch 238 to secure the cord to the lift ring 200. When the cord extends from the notch 238 to shade fabric of the Roman shade system, the weight of the shade fabric may cause the cord to be secured in the notch 238 in the lip 236 (e.g., since the knob is not able to pass through the notch 238). In some examples, the first opening 234 in the sidewall 228 at the first side 224 of the body 210 and/or a knot formed in the cord may be sized such to prevent the knot from passing through the second opening 235 when the knot is received in the cavity 232. In such examples, the knot formed in the cord may be retained in the cavity 232 and the cord may extend through the first opening 234 and wrap around the roller tube 202 adjacent to the sidewall 228 (e.g., the cord-abutment surface). In addition, the cavity 232 may be sized to prevent a knot formed in the cord from passing through the cavity 232 when the knot is received in the cavity 232 and the cord extends through the first opening 234 in the sidewall 228 at the first side 224 of the body 210. Further, the second opening 235 at the second side 226 of the body 210 may be sized to prevent a knot formed in the cord from passing through the second opening 235 when the cord is received by the cavity 232 and the cord extends through the first opening 234 and the second opening 235.

The lift ring 200 may alternatively and/or additionally be configured to facilitate attachment of ribbons (e.g., the ribbons 111) to the roller tube 202, for example, when paired with another lift ring 200 as shown in FIG. 6. The lift ring 200 may comprise one or more channels 240 (e.g., the channel 117). The channel 240 may be configured to receive one end of a pin (e.g., the pin 115) that may be attached to an end of the ribbon. The other end of the pin may be received in a respective channel in the adjacent lift ring. The ribbon may wrap around the roller tube 202 between the adjacent lift rings 200. For example, the adjacent lift rings 200 may be installed around the roller tube 202 and oriented such that the first sides 224 of the respective bodies 210 faces each other to allow the ribbon to wrap around the roller tube 202 between the sidewalls 228 of the adjacent lift rings 200. The channels 240 may be formed in, for example, the inner surface 222 of the body 210 of the lift ring 200. The pin (e.g., the end of the pin) may be captured in the respective channel 240 of the adjacent lift rings 200 between the body 210 of the lift ring 200 and the roller tube 202.

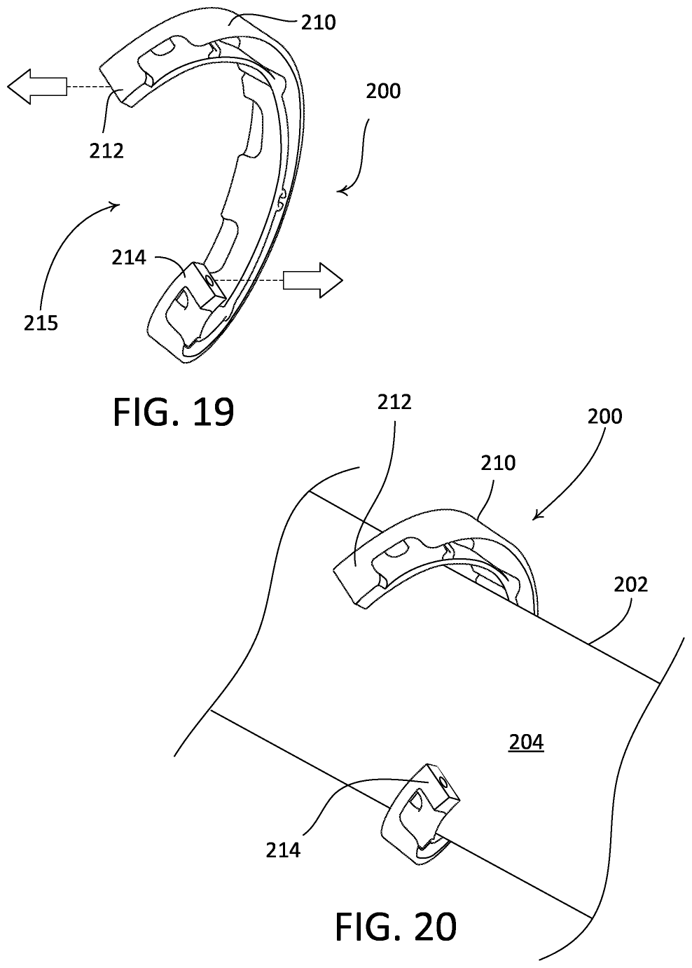

The lift ring 200 may be configured to be deformed (e.g., twisted) to be installed on the roller tube 202. FIGS. 19 and 20 are perspective views of the lift ring 200 in a deformed state illustrating how the lift ring 200 may be installed on the roller tube 202. To place the lift ring 200 into the deformed state, the first end 212 of the body 210 may pulled away from the second end 214 to enlarge the size of the gap 215 (e.g., as shown in FIG. 19). For example, the first end 212 of the body 210 may be pulled away from the second end 214 to enlarge the size of the gap 215 to be larger than a diameter of the roller tube 202 (e.g., larger than approximately 1.625 inches). When in the deformed state, the roller tube 202 may pass through the gap 215 between the first end 212 and the second end 214 of the body 210 (e.g., as shown in FIG. 20). After the roller tube 202 is received through the gap 215 between the first end 212 and the second end 214 of the body 210, the lift ring 200 may be released to allow the lift ring 200 to reform into its original shape (e.g., as shown in FIG. 16) after which the fastener 216 may be inserted into the first opening 218 in the first end 212 and the second opening 219 in the second end 214 and then tightened to secure the lift ring 200 to the roller tube 202.

The lift ring 200 may be characterized by a number of characteristics and/or features that improve the flexibility of the lift ring 200. For example, the lift ring 200 (e.g., the body 210) may be made of a suitable material (e.g., a conditioned, unfilled nylon material) that may improve the flexibility of the lift ring 200. In addition, the second side 226 of the body 210 of the lift ring 200 being open and absent of material may also improve the flexibility of the lift ring 200. Finally, the body 210 of the lift ring 200 may comprise a number of recesses 250 in the sidewall 228 on the first side 224 of the body 210. The recesses 250 may also extend into the inner surface 222 of the body 210 of the lift ring 200. The recesses 250 (e.g., lack of material along the first side 224 of the body 210) may also improve the flexibility of the lift ring 200.

Although the present disclosure has been described in relation to particular examples thereof, many other variations and modifications and other uses will become apparent to those skilled in the art. For example, although the kits, systems, and methods have been described in relation to Roman shades, it should be understood that the concepts may be applied to other types of window treatments, such as Venetian blinds and cellular shades, to list only a couple of possibilities.

1-17. (canceled)

18. A window treatment system comprising:
first and second brackets for mounting the window treatment system to a structure;
a roller tube rotatably coupled to the brackets;
a covering material extending from a location adjacent to the roller tube to a bottom end;
a lift ring extending around the roller tube, the lift ring having a body that extends from a first end to a second end and defines a central opening that receives the roller tube, the first end of the body spaced apart from the second end by a gap; and
a cord having one end attached to the roller tube via the lift ring, the cord also attached to a second end attached to the bottom end of the covering material, the cord windingly received around the roller tube such that the bottom end of the covering material may be raised and lowered in response to rotations of the roller tube in first and second angular directions, respectively;
wherein the roller tube is received in the central opening of the body, the first end of the body configured to be attached to the second end of the body for fixedly attaching the lift ring to the roller tube.

19. The window treatment system of claim 18, further comprising:
a motor drive unit received within a cavity of the roller tube at a first end of the roller tube, the motor drive unit having an end portion supported by the first bracket, the motor drive unit configured to rotate the roller tube for raising and lowering the covering material.

20. The window treatment system of claim 19, further comprising:
an idler assembly supported by the second bracket and received within the cavity of the roller tube at the second end of the roller tube, the idler assembly configured to rotatably support the roller tube.

21. The window treatment system of claim 20, further comprising:
a housing extending from a first end to a second end and supported by the first and second brackets, the housing configured to receive, at the first end of the housing, one or more batteries for powering the motor drive unit inside the roller tube.

22. The window treatment system of claim 21, wherein the housing is also configured to support a lift assistance subsystem at the second end of the housing, the lift assistance subsystem configured to provide variable lift assistance to the motor drive unit.

23. The window treatment system of claim 22, wherein the cord is configured to abut against the lift ring as the cord winds around the roller tube.

24. The window treatment system of claim 18, wherein the body of the lift ring is configured to be deformed by the first and second ends of the body being pulled in opposite directions to increase the size of the gap, such that the roller tube may be received through the gap; the body configured to reform when released, such that the roller tube is received in the central opening of the body.

25. The window treatment system of claim 24, wherein the body comprises one or more recesses in the sidewall on the first side of the body to improve the flexibility of the body.

26. The window treatment system of claim 24, wherein the body is configured to be deformed to increase the size of the gap to be greater than a diameter of the roller tube.

27. The window treatment system of claim 24, wherein the second side of the body is open and absent of material.

28. The window treatment system of claim 24, wherein the body is made of an unfilled nylon material.

29. The window treatment system of claim 18, wherein the cord comprises a first cord, and the window treatment system further comprises a second cord windingly received around the roller tube.

30. The window treatment system of claim 29, wherein the lift ring comprises a first lift ring, and the window treatment system further comprises a second lift ring against with the first cord and the second cord, respectively, abut as the first and second cords wind around the roller tube.

31. The window treatment system of claim 18, wherein the lift ring comprises a cord-attachment structure to which the cord is attached.

32. The window treatment system of claim 18, further comprising:
an enclosure in which the roller tube is located;
wherein the covering material is attached to the enclosure and extends to the bottom end of the covering material, such that the covering material hangs from the enclosure.

33. The window treatment system of claim 18, wherein the body of the lift ring comprises an outer surface and an inner surface, the inner surface configured to abut against the roller tube, the body of the lift ring further comprising a first side having a sidewall that extends from the outer surface to the inner surface and a second side that is open and absent of material.

34-45. (canceled)
